(19) United States
(12) Patent Application Publication
(10) Pub. No.: US 2024/0273844 A1
(43) Pub. Date: Aug. 15, 2024

(54) AUGMENTED REALITY STREAMING DEVICE, METHOD, AND SYSTEM INTEROPERATING WITH EDGE SERVER

(71) Applicant: Korea Electronics Technology Institute, Seongnam-si (KR)

(72) Inventors: Jun Hwan JANG, Goyang-si (KR); Woo Chool PARK, Incheon (KR); Jin Wook YANG, Uijeongbu-si (KR); Sang Pil YOON, Seoul (KR); Min Su CHOI, Seoul (KR); Jun Suk LEE, Seoul (KR); Su Ho SONG, Pyeongtaek-si (KR); Bon Jae KOO, Suwon-si (KR)

(21) Appl. No.: 18/645,955

(22) Filed: Apr. 25, 2024

Related U.S. Application Data
(63) Continuation of application No. PCT/KR2021/018760, filed on Dec. 10, 2021.

(30) Foreign Application Priority Data
Oct. 29, 2021 (KR) 10-2021-0147261

(51) Int. Cl. G06T 19/00; G06T 9/00

(52) U.S. Cl. CPC G06T 19/006; G06T 9/00

(57) ABSTRACT

An augmented reality (AR) streaming device interoperating with an edge server is proposed. The AR streaming device may include a sensing module including a camera and a certain inertia sensor, a display module streaming AR video, a communication module transmitting or receiving data to or from the edge server and the sensing module. The device may also include a memory and a processor executing a program stored in the memory. When image data and inertia data are obtained through the sensing module, the processor may perform synchronization and encoding on the image data and the inertia data to transmit to the edge server through the communication module. When segmentation rendering-processed AR video is received from the edge server, the processor may perform decoding and blending on the segmentation rendering AR video to perform control to be streamed through the display module.

### CROSS REFERENCE TO RELATED APPLICATIONS

This is a continuation application of International Patent Application No. PCT/KR2021/018760 filed on Dec. 10, 2021, which claims priority to Korean patent application No. 10-2021-0147261 filed on Oct. 29, 2021, contents of each of which are incorporated herein by reference in their entireties.

### BACKGROUND

### Technical Field

The present disclosure relates to an augmented reality (AR) streaming device, method, and system interoperating with an edge server.

### Description of Related Technology

Recently, in electronic devices, the research and development of an augmented reality (AR) function as well as a call function and a multimedia reproduction function are being done, and the use thereof is increasing. AR is technology which allows a user to see a virtual object overlapping real world with eyes. That is, AR is the field of virtual reality (VR) and is a computer graphics technique which synthesizes a virtual object or information in a real environment to allow the virtual object to be seen like an object which is in an original environment.

### SUMMARY

One aspect is an augmented reality (AR) streaming device, method, and system interoperating with an edge server, which may configure protocol for video transmission/reception and multiplexing/de-multiplexing, may perform segmentation rendering by using an edge server, and may stream AR video in real time, based on high-delay communication and a low system resource.

Another aspect is an augmented reality (AR) streaming device interoperating with an edge server that includes a camera and a certain inertia sensor, a display module streaming AR video, a communication module transmitting or receiving data to or from the edge server and the sensing module, a memory storing a program for providing an AR streaming service, based on the data, and a processor executing the program stored in the memory. In this case, as the processor executes the program, when image data and inertia data are obtained through the sensing module, the processor performs synchronization and encoding on the image data and the inertia data to transmit to the edge server through the communication module, and when segmentation rendering-processed AR video (hereinafter referred to as segmentation rendering AR video) is received from the edge server, the processor performs decoding and blending on the segmentation rendering AR video to perform control to be streamed through the display module.

In some embodiments of the present disclosure, the communication module may transmit or receive the data by using QUIC protocol based on HTTP.

In some embodiments of the present disclosure, the processor may buffer media chunk of the segmentation rendering AR video received from the edge server through the communication module in real time to perform decoding.

In some embodiments of the present disclosure, the processor may perform multiplexing of the encoded image data and inertia data by image frame units, based on ISO 23000-19 common media application format (CMAF) standard video, and may perform de-multiplexing of the received segmentation rendering AR video, based on ISO 23000-19 CMAF standard video.

In some embodiments of the present disclosure, the processor may perform blending of a region, except a content region, of the decoded pixel of the segmentation rendering AR video to perform rendering.

Another aspect is a method performed by an AR streaming device interoperating with an edge server that may include: a step of obtaining image data and inertia data through a camera and a certain inertia sensor; a step of performing synchronization and encoding on the image data and the inertia data; a step of transmitting the encoding-completed image data and inertia data to the edge server; a step of receiving segmentation rendering-processed AR video (hereinafter referred to as segmentation rendering AR video) from the edge server; a step of decoding and blending the segmentation rendering AR video; and a step of streaming the AR video through a display module.

In some embodiments of the present disclosure, the step of transmitting the encoding-completed image data and inertia data to the edge server and the step of receiving the segmentation rendering-processed AR video (hereinafter referred to as the segmentation rendering AR video) from the edge server may transmit or receive the data by using QUIC protocol based on HTTP.

In some embodiments of the present disclosure, the step of decoding and blending the segmentation rendering AR video may buffer media chunk of the segmentation rendering AR video received from the edge server through the communication module in real time to perform decoding.

In some embodiments of the present disclosure, the step of decoding and blending the segmentation rendering AR video may perform blending of a region, except a content region, of the decoded pixel of the segmentation rendering AR video to perform rendering.

Some embodiments of the present disclosure may further include: a step of performing multiplexing of the encoded image data and inertia data by image frame units, based on ISO 23000-19 common media application format (CMAF) standard video; and a step of performing de-multiplexing of the received segmentation rendering AR video, based on ISO 23000-19 CMAF standard video.

Another aspect is a lightweight AR streaming system that includes: an edge server performing recognition of a posture and a position of a user wearing the AR streaming device and performing a space configuration and matching process, based on image data and inertia data from an AR streaming device, and then, transmitting segmentation rendering-performed AR video (hereinafter referred to as segmentation rendering AR video) to the AR streaming device; and the AR streaming device obtaining image data and inertia data through a camera and a certain inertia sensor, performing synchronization and encoding on the image data and the inertia data to transmit to the edge server, and when the segmentation rendering AR video is received from the edge server, decoding and blending the segmentation rendering AR video to perform control to be streamed through the display module.

In addition, another method, another system, and a computer-readable recording medium recording a computer program for executing the method for implementing the present disclosure may be further provided.

According to an embodiment of the present disclosure described above, an edge server performs real-time segmentation rendering, and an AR streaming device allows streaming of segmentation rendering AR video generated by the edge server to be performed in real time, and thus, there is an advantage for supporting a lightweight device and a plurality of various kinds of devices by using a low resource based on ultra-low delay communication and simple video reproduction.

The effects of the present disclosure are not limited to the above-described effects, but other effects not described herein may be clearly understood by those skilled in the art from descriptions below.

### BRIEF DESCRIPTION OF THE DRAWINGS

FIG. 1 is a diagram for describing an augmented reality (AR) streaming system according to an embodiment of the present disclosure.

FIG. 2 is a block diagram for describing an AR streaming device.

FIG. 3 is a diagram for describing session configuration between an edge server and an AR streaming device.

FIG. 4 is a diagram for describing a process of processing and transmitting image data and inertia data to an edge server.

FIG. 5 is a diagram for describing a process of receiving and processing segmentation rendering AR video.

FIG. 6 is an exemplary diagram illustrating a streaming result after blending processing in an embodiment of the present disclosure.

FIG. 7 is a flowchart of an AR video streaming method according to an embodiment of the present disclosure.

### DETAILED DESCRIPTION

Current VR technology provides only a virtual space and thing as a target object, but AR combines a virtual target object with an environment of real world to more increase the effect of reality, unlike VR which is based on complete virtual world. Furthermore, a current AR service is a method, which directly installs content for AR service in a terminal (an AR streaming device) to provide, or downloads content in the AR streaming device to provide, and has a problem where a real-time streaming service is impossible and a high amount of data processing resources are needed.

The advantages, features and aspects of the present disclosure will become apparent from the following description of the embodiments with reference to the accompanying drawings, which is set forth hereinafter. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art.

The terms used herein are for the purpose of describing particular embodiments only and are not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Herein, like reference numeral refers to like element, and “and/or” include(s) one or more combinations and each of described elements. Although “first” and “second” are used for describing various elements, but the elements are not limited by the terms. Such terms are used for distinguishing one element from another element. Therefore, a first element described below may be a second element within the technical scope of the present disclosure.

Unless otherwise defined, all terms (including technical and scientific terms) used herein may be used as a meaning capable of being commonly understood by one of ordinary skill in the art. Also, terms defined in dictionaries used generally are not ideally or excessively construed unless clearly and specially defined.

The present disclosure relates to an augmented reality (AR) streaming device 100, method, and system 1, which interoperate with an edge server 200.

In an embodiment of the present disclosure, the edge server 200 performs real-time segmentation rendering, and the AR streaming device 100 allows streaming of segmentation rendering AR video generated by the edge server 200 to be performed in real time, thereby supporting a lightweight device and a plurality of devices by using a low resource based on ultra-low delay communication and simple video reproduction.

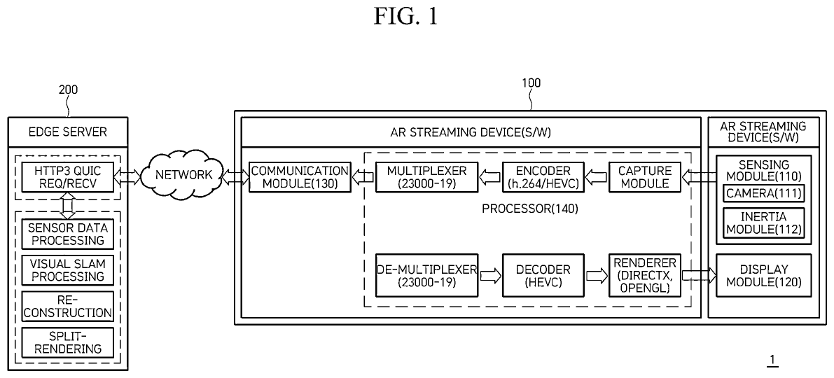

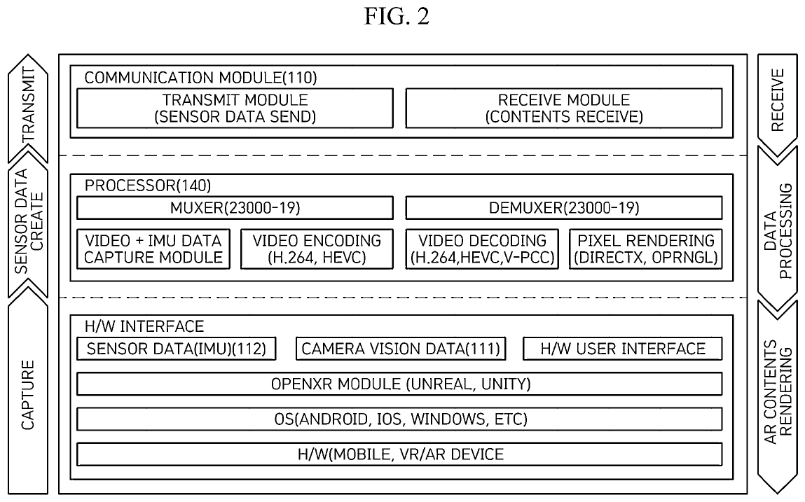

FIG. 1 is a diagram for describing an AR streaming system 1 according to an embodiment of the present disclosure. FIG. 2 is a block diagram for describing an AR streaming device 100.

The AR streaming system 1 according to an embodiment of the present disclosure includes an edge server 200 and an AR streaming device 100.

When the edge server 200 receives image data and inertia data from the AR streaming device 100, based thereon, the edge server 200 performs the recognition of a posture and a position of a user (a head position of the user) wearing the AR streaming device 100 and performs space configuration and matching, and then, performs segmentation rendering and video encoding to provide generated rendering AR video to the AR streaming device 100.

That is, an embodiment of the present disclosure is a method which directly installs content for conventional AR service in a terminal (the AR streaming device 100) to provide, or downloads content in the AR streaming device 100 to provide, and unlike that a real-time streaming service is impossible, an embodiment of the present disclosure has an advantage where the edge server 200 generates segmentation rendering AR video to transmit to the AR streaming device 100, and thus, real-time AR video streaming is possible.

The AR streaming device 100 includes a sensing module 110, a display module 120, a communication module 130, a memory (not shown), and a processor 140.

The sensing module 110 obtains image data and inertia data through a camera 111 and a certain inertia sensor 112. In an embodiment, the sensing module 110 may obtain image data through a camera interface 111 with respect to 720P and 1080P. Also, the sensing module 110 may obtain a head position of a user as inertia data from the inertia sensor 112, and at this time, the sensing module 110 may autonomously or primarily synchronize the image data and the inertia data with each other to obtain.

Furthermore, the sensing module 110 may be included in an AR device, the AR device has configured API so that an OpenXR module is compatible with a game engine (Unity, Unreal), for compatibility, and each sensing module 110 has been developed to be compatible. The display module 120 streams AR video in real time.

The communication module 130 transmits or receives data to or from the edge server 200 and the sensing module 110. In an embodiment, the communication module 130 may transmit the image data and the inertia data to the edge server 200 by using QUIC protocol based on HTTP and may receive segmentation rendering AR video from the edge server 200. An embodiment of the present disclosure applies the QUIC protocol for AR video streaming, and thus, has an advantage where it is possible to quickly transmit data with a low bandwidth.

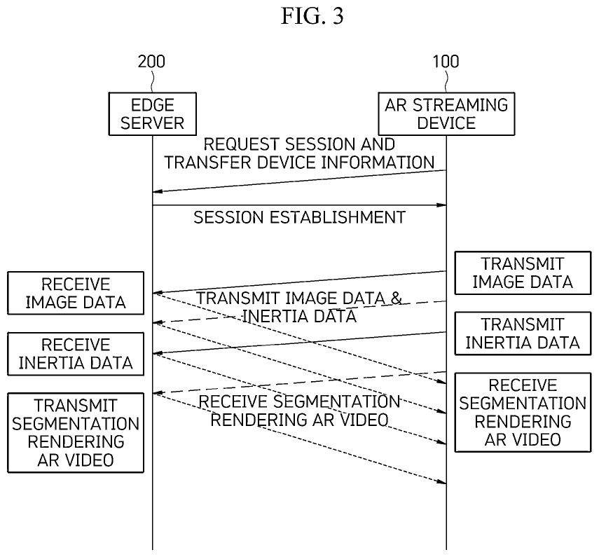

FIG. 3 is a diagram for describing session configuration between the edge server 200 and the AR streaming device 100.

Furthermore, the communication module 130 of the AR streaming device 100 transmits a session request and identification information about the AR streaming device 100 to the edge server 200, for initial communication with the edge server 200. Subsequently, when session establishment is completed, the communication module 130 may transmit the image data and the inertia data and may receive the segmentation rendering AR video with simple protocol without a separate transmission response.

The memory stores a program for providing an AR streaming service, based on data, and the processor 150 executes the program stored in the memory.

Here, the memory commonly denotes a volatile storage device and a non-volatile storage device, which continuously maintains information stored therein even when power is not supplied thereto.

For example, the memory may include NAND flash memory such as compact flash (CF) card, secure digital (SD) card, memory stick, solid state drive (SSD), and micro SD card, a magnetic computer storage device such as hard disk drive (HDD), and an optical disc drive such as CD-ROM and DVD-ROM.

Moreover, the program stored in the memory may be implemented as software or a hardware type such as field programmable gate array (FPGA) or application specific integrated circuit (ASIC) and may perform certain functions.

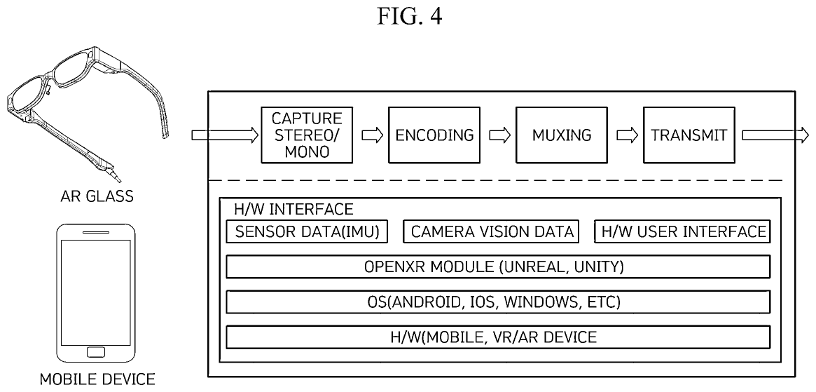

FIG. 4 is a diagram for describing a process of processing and transmitting image data and inertia data to the edge server 200.

The processor 140 compresses image data as video for low-delay transmission to transmit to the edge server 200. In detail, when the processor 140 obtains the image data and inertia data through the sensing module 110, the processor 140 synchronizes the image data and the inertia data with each other and performs encoding thereon.

At this time, the processor 140 may access an encoder so as to compress the obtained image data as a video type and may perform encoding at a speed of 30 FPS. In an embodiment, the processor may perform encoding by using h.264 and HEVC codec.

When the encoding is completed, the processor 140 may perform multiplexing of encoded image data and inertia data as standard video by using ISO 23000-19 common media application format (CMAF) capable of packaging by image frame units, so as to more quickly transmit obtained data. That is, the processor performs multiplexing based on ISO 23000-19 CMAF standard and multiplexes the encoded image data and inertia data in each track to prepare transmission.

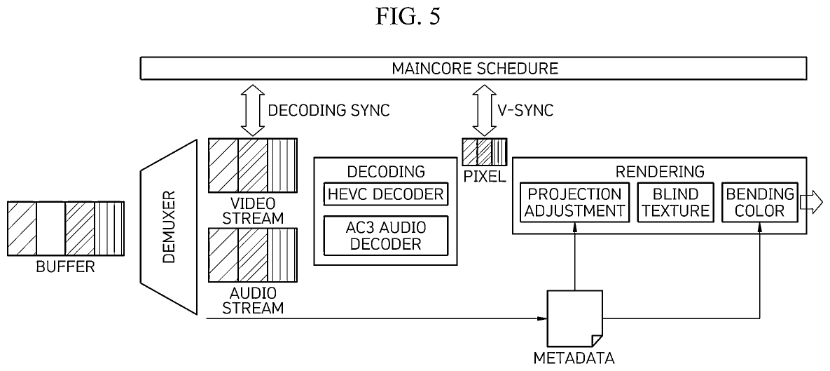

FIG. 5 is a diagram for describing a process of receiving and processing segmentation rendering AR video.

Subsequently, when the segmentation rendering AR video is generated and transmitted by the edge server 200, the processor 140 receives the segmentation rendering AR video through the communication module 130 by using QUIC protocol based on HTTP, which is low-delay protocol.

At this time, the processor 140 may buffer media chunk of the segmentation rendering AR video received from the edge server 200 through the communication module 130 and may then perform de-multiplexing.

The processor 140 performs de-multiplexing on the segmentation rendering AR video as ISO 23000-19 CMAF standard video, based on the media chunk transferred thereto. The segmentation rendering AR video is divided into a video stream and an audio stream through a de-multiplexing process.

Subsequently, the processor 140 processes decoding and blending on the segmentation rendering AR video and performs control to be streamed through the display module 120. At this time, the processor 140 may convert the video stream into pixel data to transfer to a shader of a graphics processing unit (GPU).

Moreover, the processor 140 performs blending (transparency) of the other region, except a content region, of a decoded pixel of the segmentation rendering AR video to render to the display module.

Furthermore, the processor 140 may include a main core scheduler and may control a buffer for stream transfer and rendering synchronization from a reception time of the segmentation rendering AR video through the main core scheduler. Also, the processor 140 may perform management to enable rendering at a speed of 30 FPS through the main core scheduler.

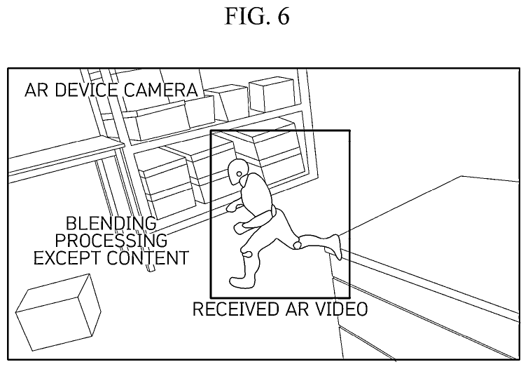

FIG. 6 is an exemplary diagram illustrating a streaming result after blending processing in an embodiment of the present disclosure.

When the segmentation rendering AR video is received, it may be seen that the other region except content is streamed through blending processing.

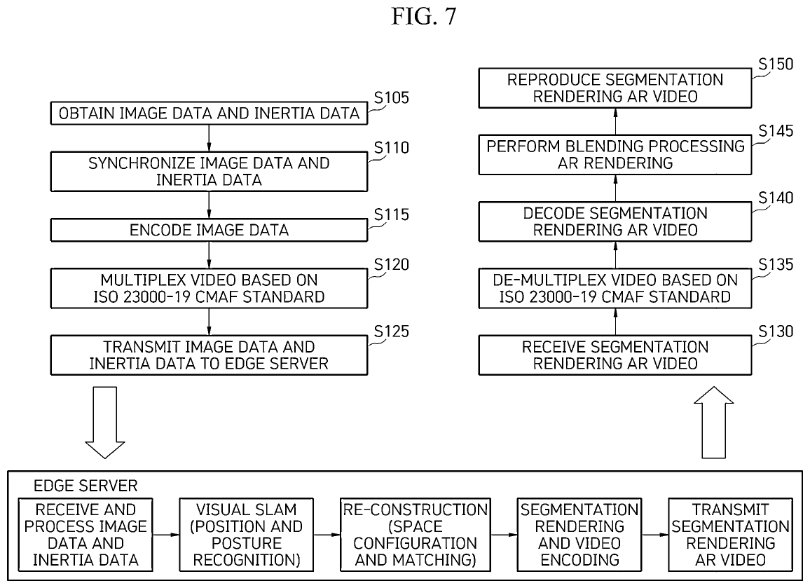

FIG. 7 is a flowchart of an AR video streaming method according to an embodiment of the present disclosure.

First, image data and inertia data are obtained through a camera and a certain inertia sensor (S105).

Subsequently, synchronization and encoding are performed on the image data and the inertia data (S110 and S115), and video multiplexing is performed based on ISO 23000-19 CMAF standard (S120).

Subsequently, the image data (video data) and the inertia data are transmitted to the edge server 200 (S125), and segmentation rendering AR video is generated by the edge server 200 and is received (S130).

Subsequently, video de-multiplexing is performed based on ISO 23000-19 CMAF standard (S135), and decoding and blending processing are performed on the segmentation rendering AR video (S140 and S145).

Subsequently, the segmentation rendering AR video is streamed through the display module (S150).

Furthermore, in the above description, steps S105 to steps S150 may be more divided into additional steps, or may be combined as fewer steps, based on an implementation example of the present disclosure. Also, some steps may be omitted depending on the case, or the order of steps may be changed. Also, despite other omitted details, details described above with reference to FIGS. 1 to 6 are applied to the AR video streaming method of FIG. 7.

The method performed by the AR streaming device 100 interoperating with the edge server 200a user according to an embodiment of the present disclosure described above may be implemented as a program (or an application) and may be stored in a medium, so as to be executed in connection with a server which is hardware.

The above-described program may include a code encoded as a computer language such as C, C++, JAVA, or machine language readable by a processor (CPU) of a computer through a device interface of the computer, so that the computer reads the program and executes the methods implemented as the program. Such a code may include a functional code associated with a function defining functions needed for executing the methods, and moreover, may include an execution procedure-related control code needed for executing the functions by using the processor of the computer on the basis of a predetermined procedure. Also, the code may further include additional information, needed for executing the functions by using the processor of the computer, or a memory reference-related code corresponding to a location (an address) of an internal or external memory of the computer, which is to be referred to by a media. Also, when the processor needs communication with a remote computer or server so as to execute the functions, the code may further include a communication-related code corresponding to a communication scheme needed for communication with the remote computer or server and information or a media to be transmitted or received in performing communication, by using a communication module of the computer.

The stored medium may denote a device-readable medium semi-permanently storing data, instead of a medium storing data for a short moment like a register, a cache, and a memory. In detail, examples of the stored medium may include read only memory (ROM), random access memory (RAM), CD-ROM, a magnetic tape, floppy disk, and an optical data storage device, but are not limited thereto. That is, the program may be stored in various recording mediums of various servers accessible by the computer or various recording mediums of the computer of a user. Also, the medium may be distributed to computer systems connected to one another over a network and may store a code readable by a computer in a distributed scheme.

Operations of an algorithm or a method described above according to the embodiments of the present disclosure may be directly implemented as hardware, implemented as a software module executed by hardware, or implemented by a combination thereof. The software module may be provided in RAM, ROM, erasable programmable read only memory (EPROM), electrical erasable programmable read only memory (EEPROM), flash memory, a hard disk, an attachable/detachable disk, and CD-ROM, or a computer-readable recording medium of an arbitrary type well known to those skilled in the art.

Hereinabove, the embodiments of the present disclosure have been described above with reference to the accompanying drawings, but it may be understood that those skilled in the art may implement the present disclosure as another detailed type without changing the technical scope or essential feature of the present disclosure. Accordingly, it should be understood that the embodiments described above are exemplary in all aspects and are not limited.

What is claimed is:

1. An augmented reality (AR) streaming device interoperating with an edge server, the AR streaming device comprising:
a sensing module including a camera and a certain inertia sensor;
a display module configured to stream AR video;
a communication module configured to transmit or receive data to or from the edge server and the sensing module;
a memory storing a program for providing an AR streaming service, based on the data; and
a processor configured to execute the program stored in the memory to:
in response to image data and inertia data being obtained through the sensing module, perform synchronization and encode on the image data and the inertia data to transmit to the edge server through the communication module, and
in response to segmentation rendering-processed AR video comprising segmentation rendering AR video is received from the edge server, decode and blend on the segmentation rendering AR video to perform control to be streamed through the display module.

2. The AR streaming device of claim 1, wherein the communication module is configured to transmit or receive the data by using QUIC protocol based on HTTP.

3. The AR streaming device of claim 1, wherein the processor is configured to buffer media chunk of the segmentation rendering AR video received from the edge server through the communication module in real time to perform decoding.

4. The AR streaming device of claim 1, wherein the processor is configured to perform multiplexing of the encoded image data and inertia data by image frame units, based on ISO 23000-19 common media application format (CMAF) standard video, and perform de-multiplexing of the received segmentation rendering AR video, based on ISO 23000-19 CMAF standard video.

5. The AR streaming device of claim 1, wherein the processor is configured to perform blending of a region, except a content region, of the decoded pixel of the segmentation rendering AR video to perform rendering.

6. A method performed by an augmented reality (AR) streaming device interoperating with an edge server, the method comprising:
obtaining image data and inertia data through a camera and a certain inertia sensor;
performing synchronization and encoding on the image data and the inertia data;
transmitting the encoding-completed image data and inertia data to the edge server;
receiving segmentation rendering-processed AR video (hereinafter referred to as segmentation rendering AR video) from the edge server;
decoding and blending the segmentation rendering AR video; and
streaming the AR video through a display module.

7. The method of claim 6, wherein transmitting the encoding-completed image data and inertia data to the edge server and the step of receiving the segmentation rendering-processed AR video comprising the segmentation rendering AR video from the edge server transmits or receives the data by using quick user datagram protocol (UDP) Internet connections (QUIC) protocol based on hypertext transfer protocol (HTTP).

8. The method of claim 6, wherein decoding and blending the segmentation rendering AR video buffers media chunk of the segmentation rendering AR video received from the edge server through the communication module in real time to perform decoding.

9. The method of claim 6, wherein decoding and blending the segmentation rendering AR video performs blending of a region, except a content region, of the decoded pixel of the segmentation rendering AR video to perform rendering.

10. The method of claim 6, further comprising:
performing multiplexing of the encoded image data and inertia data by image frame units, based on ISO 23000-19 common media application format (CMAF) standard video; and
performing de-multiplexing of the received segmentation rendering AR video, based on ISO 23000-19 CMAF standard video.

11. A lightweight augmented reality (AR) streaming system comprising:
an edge server configured to perform recognition of a posture and a position of a user wearing the AR streaming device and perform a space configuration and matching process, based on image data and inertia data from an AR streaming device, and then, transmit segmentation rendering-performed AR video comprising segmentation rendering AR video to the AR streaming device; and
the AR streaming device configured to obtain image data and inertia data through a camera and a certain inertia sensor, perform synchronization and encode on the image data and the inertia data to transmit to the edge server, and in response to the segmentation rendering AR video being received from the edge server, decode and blend the segmentation rendering AR video to perform control to be streamed through the display module.
